(19) United States
(12) Patent Application Publication
(10) Pub. No.: US 2025/0183300 A1
(43) Pub. Date: Jun. 5, 2025

(54) NONAQUEOUS ELECTROLYTIC SOLUTION SECONDARY BATTERY

(71) Applicant: Panasonic Energy Co., Ltd., Moriguchi-shi, Osaka (JP)

(72) Inventor: Takayuki Nakatsutsumi, Osaka (JP)

(73) Assignee: Panasonic Energy Co., Ltd., Moriguchi-shi, Osaka (JP)

(21) Appl. No.: 18/842,115

(22) PCT Filed: Mar. 3, 2023
(86) PCT No.: PCT/JP2023/008045

§ 371 Date: Aug. 28, 2024

(30) Foreign Application Priority Data
Mar. 9, 2022 (JP) 2022-036169

(51) Int. Cl. H01M 4/583; H01M 4/02; H01M 4/133; H01M 4/36; H01M 4/525; H01M 10/0567; H01M 10/0568; H01M 10/0569

(52) U.S. Cl. CPC H01M 4/583; H01M 4/133; H01M 4/364; H01M 4/525; H01M 10/0567; H01M 10/0568; H01M 10/0569; H01M 2004/021; H01M 2004/027; H01M 2004/028; H01M 2300/0034

(57) ABSTRACT

A negative electrode of a nonaqueous electrolytic solution secondary battery according to an aspect of the present disclosure comprises a negative electrode current collector and a negative electrode mixture layer provided on the negative electrode current collector. The negative electrode mixture layer includes: graphite particles A having an internal porosity of 5% or less; graphite particles B having an internal porosity of 8-20%; and a predetermined Si compound. When the negative electrode mixture layer is divided into two equal regions in the thickness direction, the graphite particles A are contained more in the half region closer to the outer surface than in the half region closer to the negative electrode current collector. When the concentration of a sultone is denoted as X mass % and the concentration of fluoroethylene carbonate is denoted as Y mass % in the nonaqueous electrolytic solution, 0.01≤X≤1.5, 0.5≤Y≤15, and 0.01≤X/Y≤0.5 are satisfied.

### TECHNICAL FIELD

The present disclosure relates to a non-aqueous electrolyte liquid secondary battery.

### BACKGROUND ART

Non-aqueous electrolyte liquid secondary batteries using a carbon material such as graphite as a negative electrode active material are widely used as secondary battery with a high energy density.

For example, Patent Literature 1 discloses a non-aqueous electrolyte liquid secondary battery using two types of graphite particles having different internal porosities in which a large amount of the graphite particles having a small internal porosity is contained on an outer surface side of a negative electrode mixture layer, and using a non-aqueous electrolyte liquid including a diisocyanate compound.

### CITATION LIST

### Patent Literature

PATENT LITERATURE 1: International Publication No. WO 2021/111932

### SUMMARY

In recent years, the non-aqueous electrolyte liquid secondary battery has been required to have furthermore higher output. The present inventors have made intensive investigation, and consequently found that output with a low state of charge (SOC) may be deteriorated due to repeated charge and discharge even when the negative electrode described in Patent Document 1 is used. The art described in Patent 1 does not investigate the deterioration of the output with a low SOC due to repeated charge and discharge, and still has room for improvement.

It is an advantage of the present disclosure to provide a non-aqueous electrolyte liquid secondary battery with inhibited output deterioration due to a charge-discharge cycle.

A non-aqueous electrolyte liquid secondary battery of an aspect of the present disclosure comprises: a positive electrode; a negative electrode; and a non-aqueous electrolyte liquid, wherein the negative electrode has a negative electrode current collector and a negative electrode mixture layer provided on the negative electrode current collector, the negative electrode mixture layer includes graphite particles A, graphite particles B, and a Si compound, an internal porosity of the graphite particles A is less than or equal to 5%, and an internal porosity of the graphite particles B is greater than or equal to 8% and less than or equal to 20%, the Si compound includes an ion-conductive layer and Si particles dispersed in the ion-conductive layer, when the negative electrode mixture layer is divided into two equal regions in a thickness direction, the graphite particles A are included in a larger amount in a half region on an outer surface side than in a half region on a side of the negative electrode current collector, the non-aqueous electrolyte liquid includes at least fluoroethylene carbonate and a sultone having an unsaturated bond, and in the non-aqueous electrolyte liquid, when a concentration of the sultone is X mass % and a concentration of the fluoroethylene carbonate is Y mass %, X and Y satisfy 0.01≤X≤1.5, 0.5≤Y≤15, and 0.01≤X/Y≤0.5.

According to the non-aqueous electrolyte liquid secondary battery of the present disclosure, the output deterioration due to the charge-discharge cycle may be inhibited.

### BRIEF DESCRIPTION OF DRAWINGS

FIG. 1 is a sectional view of a non-aqueous electrolyte liquid secondary battery of an example of an embodiment.

FIG. 2 is a sectional view of a negative electrode of an example of an embodiment.

FIG. 3 is a sectional view of graphite particles in a negative electrode mixture layer.

### DESCRIPTION OF EMBODIMENTS

A non-aqueous electrolyte liquid secondary battery of an aspect of the present disclosure comprises: a positive electrode; a negative electrode; and a non-aqueous electrolyte liquid, wherein the negative electrode has a negative electrode current collector and a negative electrode mixture layer provided on the negative electrode current collector, the negative electrode mixture layer includes graphite particles A, graphite particles B, and a Si compound, an internal porosity of the graphite particles A is less than or equal to 5%, and an internal porosity of the graphite particles B is greater than or equal to 8% and less than or equal to 20%, the Si compound includes an ion-conductive layer and Si particles dispersed in the ion-conductive layer, when the negative electrode mixture layer is divided into two equal regions in a thickness direction, the graphite particles A are included in a larger amount in a half region on an outer surface side than in a half region on a side of the negative electrode current collector, the non-aqueous electrolyte liquid includes at least fluoroethylene carbonate and a sultone having an unsaturated bond (hereinafter, which may be referred to as the sultone), and in the non-aqueous electrolyte liquid, when a concentration of the sultone is X mass % and a concentration of the fluoroethylene carbonate is Y mass %, X and Y satisfy 0.01≤X≤1.5, 0.5≤Y≤15, and 0.01≤X/Y≤0.5.

It is considered that the non-aqueous electrolyte liquid including fluoroethylene carbonate and the sultone at the predetermined concentrations forms a composite coating on surfaces of the graphite particles or the Si compound in the negative electrode by decomposition of fluoroethylene carbonate and the sultone to inhibit a decomposition reaction of the non-aqueous electrolyte liquid on the negative electrode surface during charge and discharge. The Si compound typically causes large change in volume with charge and discharge, and the coating on the Si compound surface is broken due to this change in volume to tend to continuously cause the decomposition reaction of the non-aqueous electrolyte liquid. The above composite coating formed with fluoroethylene carbonate and the sultone is considered to be hardly broken even by the change in volume of the Si compound, and the continuous decomposition reaction of the non-aqueous electrolyte liquid hardly occurs. The reactivity on the outer surface of the negative electrode mixture layer is also inhibited by including a larger amount of the graphite particles A having an internal porosity of less than or equal to 5% in the half region on the outer surface side of the negative electrode mixture layer than in the half region on the side of the negative electrode current collector in the negative electrode mixture layer. Thus, the decomposition reaction of the non-aqueous electrolyte liquid on the negative electrode is considered to be inhibited. As above, it is presumed that the decomposition reaction of the non-aqueous electrolyte liquid is inhibited to retain the coating with good quality on the negative electrode surface, and increase in resistance of the battery is inhibited even after a charge-discharge cycle to inhibit the output deterioration.

Hereinafter, an example of an embodiment will be described in detail with reference to the drawings. The non-aqueous electrolyte liquid secondary battery of the present disclosure is not limited to embodiments described hereinafter. The drawings referred to in the description of the embodiments are schematically described.

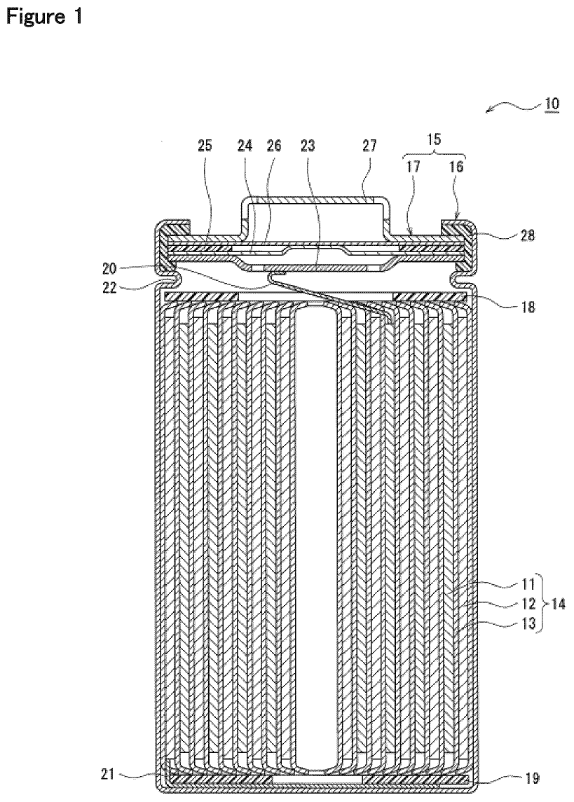

FIG. 1 is a sectional view of the non-aqueous electrolyte liquid secondary battery of an example of an embodiment. A non-aqueous electrolyte liquid secondary battery 10 illustrated in FIG. 1 comprises: a wound electrode assembly 14 in which a positive electrode 11 and a negative electrode 12 are wound via a separator 13; a non-aqueous electrolyte liquid; insulating plates 18 and 19 respectively disposed on upper and lower sides of the electrode assembly 14; and a battery case 15 housing the above members. The battery case 15 is composed of a bottomed cylindrical case body 16 and a sealing assembly 17 sealing an opening of the case body 16. Instead of the wound electrode assembly 14, an electrode assembly with another form, such as a stacked electrode assembly in which a positive electrode and a negative electrode are alternately stacked via a separator, may be applied. Examples of the battery case 15 may include: a metallic exterior housing can with a cylindrical shape, a rectangular shape, a coin shape, a button shape, or the like; and a pouch exterior formed by laminating a resin sheet and a metal sheet.

The case body 16 is, for example, a bottomed cylindrical metallic exterior housing can. A gasket 28 is provided between the case body 16 and the sealing assembly 17 to achieve sealability inside the battery. The case body 16 has, for example, a projected part 22 in which a part of a side wall thereof projects inward to support the sealing assembly 17. The projected part 22 is preferably formed in a circular shape along a circumferential direction of the case body 16, and supports the sealing assembly 17 with the upper surface thereof.

The sealing assembly 17 has a structure having the filter 23, a lower vent member 24, an insulating member 25, an upper vent member 26, and a cap 27, which are stacked in this order from the electrode assembly 14 side. Each member constituting the sealing assembly 17 has, for example, a disk shape or a ring shape, and each member except for the insulating member 25 is electrically connected to each other. The lower vent member 24 and the upper vent member 26 are connected to each other at respective central parts thereof, and the insulating member 25 is interposed between the respective circumferential parts thereof. If the internal pressure of the non-aqueous electrolyte liquid secondary battery 10 increases by heat generation due to an internal short circuit or the like, the lower vent member 24 is deformed so as to push the upper vent member 26 toward the cap 27 side and breaks, resulting in cutting off of an electrical pathway between the lower vent member 24 and the upper vent member 26, for example. If the internal pressure further increases, the upper vent member 26 breaks, and gas is discharged through the opening of the cap 27.

In the non-aqueous electrolyte liquid secondary battery 10 illustrated in FIG. 1, a positive electrode lead 20 attached to the positive electrode 11 extends through a through hole of the insulating plate 18 toward a side of the sealing assembly 17, and a negative electrode lead 21 attached to the negative electrode 12 extends through an outside of the insulating plate 19 toward a bottom of the case body 16. The positive electrode lead 20 is connected to a lower surface of the filter 23, which is a bottom plate of the sealing assembly 17, by welding or the like, and the cap 27, which is a top plate of the sealing assembly 17 electrically connected to the filter 23, becomes a positive electrode terminal. The negative electrode lead 21 is connected to a bottom inner surface of the case body 16 by welding or the like, and the case body 16 becomes a negative electrode terminal.

Hereinafter, each constituent of the non-aqueous electrolyte liquid secondary battery 10 will be described in detail.

### [Negative Electrode]

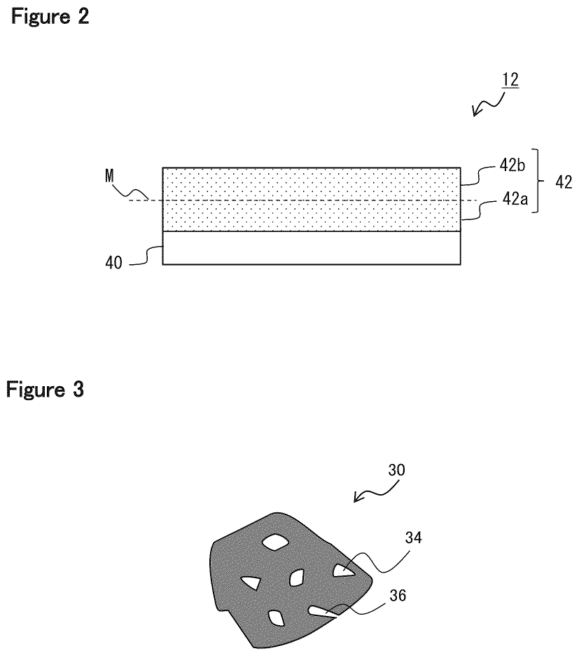

FIG. 2 is a sectional view of the negative electrode of an example of an embodiment. The negative electrode 12 has a negative electrode current collector 40 and a negative electrode mixture layer 42 provided on the negative electrode current collector 40.

For the negative electrode current collector 40, a foil of metal stable within a potential range of the negative electrode, such as copper, a film in which such a metal is disposed on a surface layer, or the like is used, for example.

The negative electrode mixture layer 42 includes graphite particles and a Si compound as negative electrode active materials. The negative electrode mixture layer 42 preferably includes a binder and the like. The negative electrode 12 may be produced by, for example, preparing a negative electrode mixture slurry including the negative electrode active material, the binder, and the like, applying and drying this negative electrode mixture slurry on the negative electrode current collector 40 to form the negative electrode mixture layer 42, and rolling this negative electrode mixture layer 42. The method for producing the negative electrode mixture layer 42 will be described in detail later.

FIG. 3 is a sectional view of the graphite particles in the negative electrode mixture layer. As shown in FIG. 3, graphite particles 30 has: closed gaps 34 not connected from a particle inside to particle surfaces (hereinafter, “internal gaps 34”); and gaps 36 connected from the particle inside to the particle surfaces (hereinafter, “external gaps 36”), in a cross-sectional view of the graphite particles 30.

The graphite particles 30 include graphite particles A having an internal porosity of less than or equal to 5% and graphite particles B having an internal porosity of greater than or equal to 8% and less than or equal to 20%. The internal porosity of the graphite particles A is less than or equal to 5% in terms of inhibition of the decomposition reaction of the non-aqueous electrolyte liquid, and the like, and preferably greater than or equal to 1% and less than or equal to 5%, and more preferably greater than or equal to 3% and less than or equal to 5%. The internal porosity of the graphite particles B is greater than or equal to 8% and less than or equal to 20% in terms of inhibition of the decomposition reaction of the non-aqueous electrolyte liquid, and the like, and preferably greater than or equal to 10% and less than or equal to 18%, and more preferably greater than or equal to 12% and less than or equal to 16%. Here, the internal porosity of the graphite particles is a two-dimensional value determined from a proportion of an area of the internal gaps 34 of the graphite particles relative to a sectional area of the graphite particles. The internal porosity of the graphite particles may be determined by the following procedure.

### <Method for Measuring Internal Porosity>

(1) A cross section of the negative electrode mixture layer is exposed. Examples of the method for exposing the cross section include a method of cutting a part of the negative electrode and processing the negative electrode mixture layer with an ion-milling apparatus (for example, IM4000PLUS, manufactured by Hitachi High-Tech Corporation) to expose the cross section of the negative electrode mixture layer.

(2) By using a scanning electron microscope, a backscattered electron image of the exposed cross section of the negative electrode mixture layer is photographed. The magnification with photographing the backscattered electron image is, for example, greater than or equal to 3,000 and less than or equal to 5,000.

(3) The sectional image obtained as above is imported into a computer, and subjected to a binarization processing by using an image analysis software (for example, ImageJ, available from National Institutes of Health). A binarization-processed image is obtained in which a particle cross section in the sectional image is converted in black and gaps present in the particle cross section are converted in white.

(4) The graphite particles A and B having a particle diameter of greater than or equal to 5 μm and less than or equal to 50 μm are selected from the binarization-processed image, and an area of a cross section of the graphite particles and an area of the internal gaps present in the cross section of the graphite particles are calculated. Here, the area of the cross section of the graphite particles refers to an area of a region surrounded by the outer circumference of the graphite particles, that is, an area of the entirety of the cross section of the graphite particles. Among the gaps present in the cross section of the graphite particles, a gap having a width of less than or equal to 3 μm may cause difficulty in judgement of whether the internal gap or the external gap on the image analysis, and thereby the gap having a width of less than or equal to 3 μm may be regarded as the internal gap. From the calculated area of the cross section of the graphite particles and the area of the internal gaps in the cross section of the graphite particles, the internal porosity of the graphite particles (the area of the internal gaps in the cross section of the graphite particles×100/the area of the cross section of the graphite particles) is calculated. The internal porosity of the graphite particles A and B is an average value of each 10 graphite particles A and B.

The graphite particles A and B are manufactured as follows, for example.

<Graphite Particles A Having Internal Porosity of Less than or Equal to 5%>

For example, cokes (precursor) being a main raw material is crushed to a predetermined size, and in an aggregated state with the binder, the crushed product is calcined at a temperature of greater than or equal to 2600° C. for graphitization, and then sieved to obtain the graphite particles A having the desired size. Here, the internal porosity may be regulated to be less than or equal to 5% with the particle diameter of the crushed precursor, the particle diameter of the precursor in the aggregated state, and the like. An average particle diameter (median diameter D50 on a volumetric basis) of the crushed precursor is preferably within a range of, for example, greater than or equal to 12 μm and less than or equal to 20 μm. When the internal porosity is reduced within a range of less than or equal to 5%, the particle diameter of the crushed precursor is preferably set to be large.

<Graphite Particles B Having Internal Porosity of Greater than or Equal to 8% and Less than or Equal to 20%>

For example, cokes (precursor) being a main raw material is crushed to a predetermined size, the crushed product is aggregated with the binder, and then in a pressed state into a block shape, calcined at a temperature of greater than or equal to 2600° C. for graphitization. The block-shaped product after the graphitization is crushed and sieved to obtain graphite particles B having the desired size. Here, the internal porosity may be regulated to be greater than or equal to 8% and less than or equal to 20% with an amount of a volatile component added into the block-shaped product. When a part of the binder added into the cokes (precursor) is evaporated during the calcining, the binder may be used as the volatile component. Examples of such a binder include pitch.

The graphite particles A and B are not particularly limited to natural graphite, artificial graphite, and the like, but preferably artificial graphite in terms of ease of regulating the internal porosity, and the like. A face spacing of a (002) face (d₀₀₂) by X-ray wide-angle diffraction of the graphite particles A and B is preferably, for example, greater than or equal to 0.3354 nm, more preferably greater than or equal to 0.3357 nm, preferably less than 0.340 nm, and more preferably less than or equal to 0.338 nm. A crystalline size (Lc (002)) of the graphite particles A and B determined by X-ray diffraction is preferably, for example, greater than or equal to 5 nm, preferably greater than or equal to 10 nm, preferably less than or equal to 300 nm, and more preferably less than or equal to 200 nm. The face spacing (d₀₀₂) and the crystallite size (Lc (002)) within the above ranges tend to increase the battery capacity of the non-aqueous electrolyte liquid secondary battery compared with a case where not satisfying the above ranges.

When the negative electrode mixture layer 42 illustrated in FIG. 2 is divided into two equal regions in a thickness direction, the graphite particles A are included in a larger amount in a half region 42b on an outer surface side than in a half region 42a on a side of the negative electrode current collector. This inhibits the decomposition reaction of the non-aqueous electrolyte liquid on the negative electrode, and consequently inhibits the output deterioration. The description “the negative electrode mixture layer 42 is divided into two equal regions in a thickness direction” means, when a stacking direction of the negative electrode current collector 40 and the negative electrode mixture layer 42 is specified as the thickness direction of the negative electrode mixture layer 42, division in half at the middle M of the thickness of the negative electrode mixture layer 42. Among the divided two equal regions in the thickness direction of the negative electrode mixture layer 42, the negative electrode mixture layer 42 closely positioned viewed from the negative electrode current collector 40 is specified as the half region 42a on a side of the negative electrode current collector, and the negative electrode mixture layer 42 far positioned viewed from the negative electrode current collector 40 is specified as the half region 42b on the outer surface side.

The graphite particles A are included in a larger amount in the half region 42b on the outer surface side than in the half region 42a on the side of the negative electrode current collector, and a ratio between the graphite particles A and the graphite particles B in the half region 42b on the outer surface side is preferably greater than or equal to 20:80 and less than or equal to 100:0, and more preferably greater than or equal to 50:50 and less than or equal to 100:0 at a mass ratio in terms of inhibition of the decomposition reaction of the non-aqueous electrolyte liquid on the negative electrode. A ratio between the graphite particles A and the graphite particles B in the half region 42a on the side of the negative electrode current collector is preferably greater than or equal to 10:90 and less than or equal to 0:100, and more preferably 0:100 at a mass ratio.

A content of the graphite particles A in the negative electrode mixture layer 42 is, for example, greater than or equal to 20 mass % and less than or equal to 80 mass %, and may be greater than or equal to 25 mass % and less than or equal to 50 mass % relative to the total mass of the graphite particles A and the graphite particles B.

The Si compound included in the negative electrode mixture layer 42 includes an ion-conductive layer and Si particles dispersed in the ion-conductive layer. A content of the Si particles in the Si compound is preferably greater than or equal to 40 mass % and less than or equal to 70 mass % in terms of increase in the capacity. The ion conductive layer is a silicate phase, an amorphous carbon phase, or the like.

SiO, which is an example of the Si compound, has a particle structure in which fine Si particles are dispersed in the silicate phase. A preferable SiO has a sea-island structure in which fine Si particles are substantially uniformly dispersed in a matrix of amorphous silicon oxide.

SiC, which is another example of the Si compound, has a particle structure in which fine Si particles are dispersed in the amorphous carbon phase. A preferable SiC has a sea-island structure in which fine Si particles are substantially uniformly dispersed in a matrix of the amorphous carbon phase.

The ion-conductive layer is preferably the amorphous carbon phase. That is, the Si compound is preferably SiC.

A content of the Si compound in the negative electrode mixture layer is, for example, greater than or equal to 5 mass % and less than or equal to 20 mass % relative to the total mass of the negative electrode active material. This may inhibit deterioration of the charge-discharge cycle characteristics while increasing the battery capacity. The content rate of the Si compound in the half region 42a on the side of the negative electrode current collector and the content rate of the Si compound in the half region 42b on the outer surface side may be different, but preferably substantially equal.

An example of the method for producing the negative electrode mixture layer 42 will be described. For example, the negative electrode active material including the graphite particles B (as necessary the graphite particles A), the binder, and a solvent such as water are mixed to prepare a negative electrode mixture slurry for the side of the negative electrode current collector. Separately, the negative electrode active material including the graphite particles A (as necessary the graphite particles B) in a larger amount than in the negative electrode mixture slurry for the side of the negative electrode current collector, the binder, and a solvent such as water are mixed to prepare a negative electrode mixture slurry for the outer surface side. The negative electrode mixture slurry for the side of the negative electrode current collector is applied on both surfaces of the negative electrode current collector, dried, and then, on the coating of the negative electrode mixture slurry for the side of the negative electrode current collector, the negative electrode mixture slurry for the outer surface side is applied on both the surfaces, and dried to form the negative electrode mixture layer 42. In the above method, the negative electrode mixture slurry for the side of the negative electrode current collector is applied and dried, and then the negative electrode mixture slurry for the outer surface side is applied. However, after the negative electrode mixture slurry for the side of the negative electrode current collector is applied and before the drying, the negative electrode mixture slurry for the outer surface side may be applied. Alternatively, the negative electrode mixture slurry for the side of the negative electrode current collector and the negative electrode mixture slurry for the outer surface side may be simultaneously applied.

Examples of the binder include a fluororesin, a polyimide resin, an acrylic resin, a polyolefin resin, polyacrylonitrile (PAN), styrene-butadiene rubber (SBR), nitrile-butadiene rubber (NBR), carboxymethylcellulose (CMC) or a salt thereof, polyacrylic acid (PAA) or a salt thereof (which may be PAA-Na, PAA-K, and the like, or a partially neutralized salt), and polyvinyl alcohol (PVA). These may be used singly, or in combination of two or more thereof.

### [Positive Electrode]

The positive electrode 11 is composed of, for example, a positive electrode current collector such as metal foil and a positive electrode mixture layer formed on the positive electrode current collector. For the positive electrode current collector, a foil of a metal stable within a potential range of the positive electrode, such as aluminum, a film in which such a metal is disposed on a surface layer, or the like may be used. The positive electrode mixture layer includes, for example, a positive electrode active material, a binder, a conductive agent, and the like.

The positive electrode 11 may be produced by, for example, applying a positive electrode mixture slurry including a positive electrode active material, a binder, a conductive agent, and the like on a positive electrode current collector, drying the coating to form a positive electrode mixture layer, and then rolling this positive electrode mixture layer.

Examples of the positive electrode active material may include a lithium-transition metal composite oxide containing a transition metal element such as Ni. The lithium-transition metal composite oxide preferably includes Ni and at least one element selected from the group consisting of Mn, Co, and Al. A content of Ni in the lithium-transition metal composite oxide is, for example, greater than or equal to 80 mol % and less than or equal to 95 mol % relative to a total number of moles of the metal elements excluding Li. The lithium-transition metal composite oxide may be represented by, for example, the general formula LiₐNiₓM1_{y}M1_{z}O_{2-b}, wherein 0.8≤a≤1.2, 0.8≤x≤0.95, 0.05≤y≤0.2, 0≤z≤0.15, 0≤b<0.05, x+y+z=1, M1 represents at least one element selected from the group consisting of Mn, Co, and Al, and M2 represents at least one element selected from the group consisting of Fe, Ti, Si, Nb, Zr, Mo, and Zr.

Examples of the conductive agent include carbon-based particles such as carbon black (CB), acetylene black (AB), Ketjenblack, carbon nanotube (CNT), graphene, and graphite. These may be used singly, or in combination of two or more.

Examples of the binder include fluororesins such as polytetrafluoroethylene (PTFE) and polyvinylidene fluoride (PVdF), polyimide resins, acrylic resins, polyolefin resins, and polyacrylonitrile (PAN). These may be used singly, or in combination of two or more.

### [Non-Aqueous Electrolyte Liquid]

The non-aqueous electrolyte liquid includes a non-aqueous solvent and an electrolyte salt dissolved in the non-aqueous solvent. The non-aqueous electrolyte liquid includes at least fluoroethylene carbonate (FEC) and a sultone having an unsaturated bond as the non-aqueous solvent. In the non-aqueous electrolyte liquid, when a concentration of the sultone is X mass % and a concentration of FEC is Y mass %, X and Y satisfy 0.01≤X≤1.5, 0.5≤Y≤15, and 0.01≤X/Y≤0.5. This inhibits the decomposition reaction of the non-aqueous electrolyte liquid on the negative electrode surface during charge and discharge. This is presumably because FEC and the sultone are decomposed to form a composite coating on the negative electrode surface.

The sultone is not particularly limited as long as it has an unsaturated bond. Examples of the sultone include 1-propene-1,3-sultone and 1-butene-1,4-sultone. The sultone is preferably 1-propene-1,3-sultone.

The non-aqueous electrolyte liquid may include a non-aqueous solvent other than FEC and the sultone. As the non-aqueous solvent other than FEC and the sultone, carbonates, lactones, ethers, ketones, esters, and the like may be used, and two or more of these solvents may be mixed for use. When two or more of the solvents are mixed for use, a mixed solvent including a cyclic carbonate and a chain carbonate is preferably used. For example, ethylene carbonate (EC), propylene carbonate (PC), butylene carbonate (BC), or the like may be used as the cyclic carbonate, and dimethyl carbonate (DMC), ethyl methyl carbonate (EMC), diethyl carbonate (DEC), or the like may be used as the chain carbonate. As the esters, carbonate esters such as methyl acetate (MA) and methyl propionate (MP) are preferably used. The non-aqueous solvent may contain a halogen-substituted derivative other than FEC, such as methyl fluoropropionate (FMP).

The non-aqueous electrolyte liquid preferably includes lithium bis(fluorosulfonyl)imide (LiFSI) as the electrolyte salt. This makes the effect of inhibiting the output deterioration more remarkable. This is presumably because the coating with good quality is formed on the negative electrode surface. When a concentration of LiFSI in the non-aqueous electrolyte liquid is Z mass %, Z and X preferably satisfy 0.01≤Z≤5 and 0.1≤X/Z≤1.

The electrolyte salt may include a lithium sulfonylimide other than LiFSI. Examples of the lithium sulfonylimide other than LiFSI include lithium bis(trifluoromethanesulfonyl)imide, lithium bis(nonafluorobutanesulfonyl)imide, and lithium bis(pentafluoroethanesulfonyl)imide (LIBETI). These may be used singly, or in combination of two or more.

The electrolyte salt may include a lithium salt other than the lithium sulfonylimide. Examples of the lithium salt other than the lithium sulfonylimide include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1<x<6, and “n” represents 1 or 2), LiB₁₀Cl₁₀, LiCl, LiBr, LiI, lithium chloroborane, a lithium lower aliphatic carboxylate, and borate salts such as Li₂B₄O₇ and Li(B(C₂O₄)F₂). Among them, LiPF₆ is preferably used from the viewpoints of ion conductivity, electrochemical stability, and the like. A concentration of LiPF₆ is preferably greater than or equal to 0.8 mol and less than or equal to 1.8 mol per litter of the non-aqueous solvent.

The non-aqueous electrolyte liquid may contain vinylene carbonate (VC), ethylene sulfite (ES), cyclohexylbenzene (CHB), ortho-terphenyl (OTP), and a propane-sultone-type compound. Among them, VC is preferably contained from the viewpoints of increase in the capacity and the like. An amount of VC added is not particularly limited, and for example greater than or equal to 0.1 mass % and less than or equal to 5 mass % relative to a total mass of the non-aqueous electrolyte liquid.

### [Separator]

For the separator 13, a porous sheet having an ion permeation property and an insulation property is used, for example. Specific examples of the porous sheet include a fine porous thin film, a woven fabric, and a nonwoven fabric. As a material for the separator, olefin resins such as polyethylene or polypropylene, cellulose, or the like is preferable. The separator 13 may be a laminate having a cellulose fiber layer and a thermoplastic resin fiber layer such as an olefin resin. The separator may be a multilayer separator including a polyethylene layer and a polypropylene layer, or a separator in which a material such as an aramid resin and a ceramic is applied on a surface of the separator may also be used.

### EXAMPLES

Hereinafter, the present disclosure will be further described with Examples, but the present disclosure is not limited to these Examples.

### Example 1

### [Production of Positive Electrode]

As a positive electrode active material, aluminum-containing lithium nickel cobaltate (LiNi_{0.91}Co_{0.04}Al_{0.05}O₂) was used. Mixing 100 parts by mass of the above positive electrode active material, 1 part by mass of acetylene black, and 0.9 parts by mass of polyvinylidene fluoride was performed in an N-methyl-2-pyrrolidone (NMP) solvent to prepare a positive electrode mixture slurry. This slurry was applied on both surfaces of aluminum foil with 15 μm in thickness, the coating was dried, and then the coating was rolled with a roller to produce a positive electrode in which a positive electrode mixture layer was formed on both the surfaces of the positive electrode current collector.

### [Production of Graphite Particles A]

Cokes was crushed until the average particle diameter (median diameter D50) was 12 μm. Into the crushed cokes, pitch as a binder was added to aggregate the cokes until the average particle diameter (median diameter D50) was 17 μm. This aggregate was calcined at a temperature of 2800° C. for graphitization, and then sieved by using a sieve with 250 mesh to obtain graphite particles A having an average particle diameter (median diameter D50) of 23 μm.

### [Production of Graphite Particles B]

Cokes was crushed until the average particle diameter (median diameter D50) was 15 μm. Into the crushed cokes, pitch as a binder was added to aggregate the cokes and to produce a block-shaped product having a density of greater than or equal to 1.6 g/cm³ and less than or equal to 1.9 g/cm³ at an isotropic pressure. This block-shaped molded product was calcined at a temperature of 2800° C. for graphitization. Then, the graphitized block-shaped molded product was crushed, and sieved by using a sieve with 250 mesh to obtain graphite particles B having an average particle diameter (median diameter D50) of 23 μm.

### [Production of Negative Electrode]

Mixed graphite obtained by mixing 60 parts by mass of the graphite particles A and 40 parts by mass of the graphite particles B was mixed with SiC at a mass ratio of 92:8, and this was used as a negative electrode active material A to be included in a half region on an outer surface side of the negative electrode mixture layer. The negative electrode active material A, carboxymethylcellulose (CMC), and styrene-butadiene rubber (SBR) were mixed at a mass ratio of 100:1:1 to prepare a negative electrode mixture slurry for an outer surface side. The graphite particles B and SiC were mixed at a mass ratio of 92:8, and this mixture was used as a negative electrode active material B to be included in a half region on a side of the negative electrode current collector of the negative electrode mixture layer. The negative electrode active material B, carboxymethylcellulose (CMC), and styrene-butadiene rubber (SBR) were mixed at a mass ratio of 100:1:1 to prepare a negative electrode mixture slurry on the side of the negative electrode current collector. As noted above, the proportions of the Si compound relative to the total mass of the negative electrode active material were equal on the outer surface side and the current collector side. A content of Si particles in SiC was 50 mass %.

The negative electrode mixture slurry for the side of the negative electrode current collector was applied on both surfaces of copper foil with 8 μm in thickness, the coating was dried, then the negative electrode mixture slurry for the outer surface side was applied on the coating, dried, and the coating was rolled with a roller to produce a negative electrode in which the negative electrode mixture layer was formed on both the surfaces of the negative electrode current collector. That is, the graphite particles A: the graphite particles B was 60:40 at a mass ratio in the half region on the outer surface side of the negative electrode mixture layer, and the graphite particles A: the graphite particles B was 0:100 at a mass ratio in the half region on the side of the negative electrode current collector of the negative electrode mixture layer. The internal porosities of the graphite particles A and the graphite particles B in the produced negative electrode were measured to find 3% and 15%, respectively.

### [Production of Non-Aqueous Electrolyte Liquid]

Into a mixed solvent in which ethylene carbonate (EC), ethyl methyl carbonate (EMC), and dimethyl carbonate (DMC) were mixed at a volume ratio of 20:5:75, LiPF₆ was dissolved at a concentration of 1.35 mol/L. Further, 3 mass % of vinylene carbonate (VC) was added relative to the total mass of the mixed solvent and LiPF₆, and this mixture was used as a non-aqueous electrolyte liquid base. Then, into 100 parts by mass of the non-aqueous electrolyte liquid base, 0.5 parts by mass of 1-propene-1,3-sultone, 2 parts by mass of fluoroethylene carbonate (FEC), and 1 part by mass of lithium bis(fluorosulfonyl)imide (LiFSI) were added to produce a non-aqueous electrolyte liquid. Thus, in the non-aqueous electrolyte liquid, a concentration X of the sultone was 0.5 mass %, a concentration Y of FEC was 1.9 mass %, and a concentration Z of LiFSI was 1.0 mass %.

### [Production of Secondary Battery]

(1) A positive electrode lead made of aluminum was attached to the positive electrode current collector, and a negative electrode lead made of nickel-copper-nickel was attached to the negative electrode current collector. Then, the positive electrode and the negative electrode were wound via a separator made of polyethylene to produce a wound electrode assembly.

(2) Insulating plates were disposed on upper and lower sides of the electrode assembly respectively, the negative electrode lead was welded with the case body, the positive electrode lead was welded with a sealing assembly, and the electrode assembly was housed in the case body.

(3) The non-aqueous electrolyte liquid was injected into the case body by a pressure reduction method, and then an opening of the case body was caulked with a sealing assembly via a gasket. This was used as a secondary battery.

### [Evaluation of DCIR Increasing Rate]

Under a temperature environment of 25° C., the secondary battery in a fully discharged at a constant current of 0.2 C until 2.5 V was charged at a constant current of 0.3 C until a cell voltage reached 3.4 V, and then charged at a constant voltage of 3.4 V until a current value reached 0.002 C. At this time, SOC of the secondary battery was 10%. After the secondary battery was left for stand for 2 hours with an opened circuit, the secondary battery was discharged at a constant current of 0.5 C for 10 seconds. From an opened circuit voltage (OCV), a closed circuit voltage (CCV) after 10 seconds from the discharge, and a current value (I₁₀ₛ) after 10 seconds from the discharge, direct-current resistance (DCIR) was calculated with the following formula to specify this value as initial DCIR.

$$DCIR = ( OCV - CCV ) / {I}_{10 s}$$

Then, under a temperature environment of 25° C., the secondary battery was charged at a constant current of 0.3 C until a cell voltage reached 4.2 V, and then charged at a constant voltage of 4.2 V until a current value reached 0.02 C. Thereafter, the secondary battery was discharged at a constant current of 0.5 C until 2.5 V. This charge and discharge was specified as one cycle, and 100 cycles were performed.

DCIR of the secondary battery after the 100 cycles was calculated in the same manner as in the above initial DCIR to specify this value as a DCIR after the cycles. With the above initial DCIR and the DCIR after the cycles, a DCIR increasing rate was determined with the following formula.

DCIR increasing rate (%)=(DCIR after cycles−Initial DCIR)/Initial DCIR×100

### Example 2

A non-aqueous electrolyte liquid secondary battery was produced and evaluated in the same manner as in Example 1 except that: in the production of the negative electrode, the mixing ratio between the mixed graphite and SiC in the negative electrode active material A and the mixing ratio between the graphite particle B and SiC in the negative electrode active material B were both changed to 90:10 at a mass ratio; and in the production of the non-aqueous electrolyte liquid, the amount of FEC added was changed to 5 parts by mass. In the non-aqueous electrolyte liquid, the concentration X of the sultone was 0.5 mass %, the concentration Y of FEC was 4.7 mass %, and the concentration Z of LiFSI was 0.9 mass %.

### Example 3

A non-aqueous electrolyte liquid secondary battery was produced and evaluated in the same manner as in Example 1 except that: in the production of the negative electrode, the mixing ratio between the mixed graphite and SiC in the negative electrode active material A and the mixing ratio between the graphite particle B and SiC in the negative electrode active material B were both changed to 88:12 at a mass ratio; and in the production of the non-aqueous electrolyte liquid, the amount of FEC added was changed to 10 parts by mass. In the non-aqueous electrolyte liquid, the concentration X of the sultone was 0.4 mass %, the concentration Y of FEC was 9.0 mass %, and the concentration Z of LiFSI was 0.9 mass %.

### Example 4

A non-aqueous electrolyte liquid secondary battery was produced and evaluated in the same manner as in Example 1 except that, in the production of the non-aqueous electrolyte liquid, the amount of 1-propene-1,3-sultone added was changed to 0.2 parts by mass, and the amount of FEC added was changed to 5 parts by mass. In the non-aqueous electrolyte liquid, the concentration X of the sultone was 0.2 mass %, the concentration Y of FEC was 4.7 mass %, and the concentration Z of LiFSI was 0.9 mass %.

### Example 5

A non-aqueous electrolyte liquid secondary battery was produced and evaluated in the same manner as in Example 1 except that: in the production of the negative electrode, the mixing ratio between the mixed graphite and SiC in the negative electrode active material A and the mixing ratio between the graphite particle B and SiC in the negative electrode active material B were both changed to 95:5 at a mass ratio; and in the production of the non-aqueous electrolyte liquid, the amount of 1-propene-1,3-sultone added was changed to 0.1 part by mass, and the amount of FEC added was changed to 5 parts by mass. In the non-aqueous electrolyte liquid, the concentration X of the sultone was 0.1 mass %, the concentration Y of FEC was 4.7 mass %, and the concentration Z of LiFSI was 0.9 mass %.

### Example 6

A non-aqueous electrolyte liquid secondary battery was produced and evaluated in the same manner as in Example 1 except that, in the production of the non-aqueous electrolyte liquid, the amount of LiFSI was changed to 4 parts by mass. In the non-aqueous electrolyte liquid, the concentration X of the sultone was 0.5 mass %, the concentration Y of FEC was 1.9 mass %, and the concentration Z of LiFSI was 3.8 mass %.

### Comparative Example 1

A non-aqueous electrolyte liquid secondary battery was produced and evaluated in the same manner as in Example 1 except that: in the production of the negative electrode, the negative electrode mixture slurry for the outer surface side was applied on both the surface of copper foil, the coating was dried, and then the negative electrode mixture slurry for the side of the negative electrode current collector was applied on the coating.

### Comparative Example 2

A non-aqueous electrolyte liquid secondary battery was produced and evaluated in the same manner as in Example 1 except that, in the production of the non-aqueous electrolyte liquid, 1-propene-1,3-sultone was not added. In the non-aqueous electrolyte liquid, the concentration Y of FEC was 1.9 mass %, and the concentration Z of LiFSI was 1.0 mass %.

### Comparative Example 3

A non-aqueous electrolyte liquid secondary battery was produced and evaluated in the same manner as in Example 1 except that, in the production of the non-aqueous electrolyte liquid, the amount of 1-propene-1,3-sultone added was changed to 2.0 parts by mass. In the non-aqueous electrolyte liquid, the concentration X of the sultone was 1.9 mass %, the concentration Y of FEC was 1.9 mass %, and the concentration Z of LiFSI was 1.0 mass %.

Table 1 shows the evaluation results of the secondary batteries of Examples and Comparative Examples. All the evaluations were performed under conditions same as the conditions described in Example 1. Table 1 also shows the mass ratio between the graphite particles A and the graphite particles B in the half area on the outer surface side and the half area on the current collector side of the negative electrode mixture layer, the content of SiC in the negative electrode mixture layer, the concentration X of 1-propene-1,3-sultone, the concentration Y of FEC, and the concentration Z of LiFSI relative to the non-aqueous electrolyte liquid base, X/Y, and X/Z.

TABLE 1

| | Negative electrode | | | | | | | | | |
|---|---|---|---|---|---|---|---|---|---|---|
| | Graphite particles A:graphite | | | | | | | | | |
| | particles B | | | | | | | | | Evaluation |
| | | Half area on | | | Electrolyte liquid | | | | | results |
| | Half area on | side of negative | Si compound | | Sultone | FEC | LiFSI | | | DCIR |
| | outer | electrode current | | Content | concentration | concentration | concentration | X/ | X/ | increasing |
| | surface side | collector | Type | [mass %] | X [mass %] | Y [mass %] | Z [mass %] | Y | Z | rate [%] |
| Example 1 | 60:40 | 0:100 | SiC | 8 | 0.5 | 1.9 | 1.0 | 0.25 | 0.5 | 32 |
| Example 2 | 60:40 | 0:100 | SiC | 10 | 0.5 | 4.7 | 0.9 | 0.1 | 0.5 | 22 |
| Example 3 | 60:40 | 0:100 | SiC | 12 | 0.4 | 9.0 | 0.9 | 0.05 | 0.5 | 26 |
| Example 4 | 60:40 | 0:100 | SiC | 8 | 0.2 | 4.7 | 0.9 | 0.04 | 0.2 | 44 |
| Example 5 | 60:40 | 0:100 | SiC | 5 | 0.1 | 4.7 | 0.9 | 0.02 | 0.1 | 32 |
| Example 6 | 60:40 | 0:100 | SiC | 8 | 0.5 | 1.9 | 3.8 | 0.25 | 0.13 | 34 |
| Comparative | 0:100 | 60:40 | SiC | 8 | 0.5 | 1.9 | 1.0 | 0.25 | 0.5 | 125 |
| Example 1 | | | | | | | | | | |
| Comparative | 60:40 | 0:100 | SiC | 8 | 0 | 1.9 | 1.0 | 0 | 0 | 131 |
| Example 2 | | | | | | | | | | |
| Comparative | 60:40 | 0:100 | SiC | 8 | 1.9 | 1.9 | 1.0 | 1 | 2 | 105 |
| Example 3 | | | | | | | | | | |

The secondary batteries of Examples inhibited the rate of increase in DCIR relative to the initial DCIR even after repeated charge and discharge. Meanwhile, the secondary batteries of Comparative Examples did not inhibit the rate of increase in DCIR relative to the initial DCIR after repeated charge and discharge compared with Examples. Therefore, it is found that the output deterioration due to the charge-discharge cycle may be inhibited by containing the two types of graphite particles having different internal porosities and the predetermined Si compound in the negative electrode mixture layer, by containing the graphite particles having a small internal porosity in the half region on the outer surface side of the negative electrode mixture layer, and by containing the sultone and fluoroethylene carbonate at the predetermined concentrations in the non-aqueous electrolyte liquid.

### REFERENCE SIGNS LIST

10 Non-aqueous electrolyte liquid secondary battery, 11 Positive electrode, 12 Negative electrode, 13 Separator, 14 Electrode assembly, 15 Battery case, 16 Case body, 17 Sealing assembly, 18, 19 Insulating plate, 20 Positive electrode lead, 21 Negative electrode lead, 22 Projected part, 23 Filter, 24 Lower vent member, 25 Insulating member, 26 Upper vent member, 27 Cap, 28 Gasket, 30 Graphite particle, 34 Internal gap, 36 External gap, 40 Negative electrode current collector, 42 Negative electrode mixture layer, 42a Half region on side of negative electrode current collector, 42b Half region on outer surface side

1. A non-aqueous electrolyte liquid secondary battery, comprising:
a positive electrode;
a negative electrode; and
a non-aqueous electrolyte liquid, wherein
the negative electrode has a negative electrode current collector and a negative electrode mixture layer provided on the negative electrode current collector,
the negative electrode mixture layer includes graphite particles A, graphite particles B, and a Si compound as negative electrode active materials,
an internal porosity of the graphite particles A is less than or equal to 5%, and an internal porosity of the graphite particles B is greater than or equal to 8% and less than or equal to 20%,
the Si compound includes an ion-conductive layer and Si particles dispersed in the ion-conductive layer,
when the negative electrode mixture layer is divided into two equal regions in a thickness direction, the graphite particles A are included in a larger amount in a half region on an outer surface side than in a half region on a side of the negative electrode current collector,
the non-aqueous electrolyte liquid includes at least fluoroethylene carbonate and a sultone having an unsaturated bond, and
in the non-aqueous electrolyte liquid, when a concentration of the sultone is X mass % and a concentration of the fluoroethylene carbonate is Y mass %, X and Y satisfy 0.01≤X≤1.5, 0.5≤Y≤15, and 0.01≤X/Y≤0.5.

2. The non-aqueous electrolyte liquid secondary battery according to claim 1, wherein a content of the graphite particles A in the negative electrode mixture layer is greater than or equal to 20 mass % and less than or equal to 80 mass % relative to a total mass of the graphite particles A and the graphite particles B.

3. The non-aqueous electrolyte liquid secondary battery according to claim 1, wherein a content of the Si particles in the Si compound is greater than or equal to 40 mass % and less than or equal to 70 mass %.

4. The non-aqueous electrolyte liquid secondary battery according to claim 1, wherein the ion-conductive layer is an amorphous carbon phase.

5. The non-aqueous electrolyte liquid secondary battery according to claim 1, wherein a content of the Si compound in the negative electrode mixture layer is greater than or equal to 5 mass % and less than or equal to 20 mass % relative to a total mass of the negative electrode active material.

6. The non-aqueous electrolyte liquid secondary battery according to claim 1, wherein the non-aqueous electrolyte liquid includes lithium bis(fluorosulfonyl)imide.

7. The non-aqueous electrolyte liquid secondary battery according to claim 6, wherein, when a concentration of lithium bis(fluorosulfonyl)imide in the non-aqueous electrolyte liquid is Z mass %, Z and X satisfy 0.01≤Z≤5 and 0.1≤X/Z≤1.

8. The non-aqueous electrolyte liquid secondary battery according to claim 1, wherein the sultone is 1-propene-1,3-sultone.

9. The non-aqueous electrolyte liquid secondary battery according to claim 1, wherein
the positive electrode includes a lithium-transition metal composite oxide,
the lithium-transition metal composite oxide includes Ni and at least one element selected from the group consisting of Mn, Co, and Al, and
a content of Ni in the lithium-transition metal composite oxide is greater than or equal to 80 mol % and less than or equal to 95 mol % relative to a total number of moles of metal elements excluding Li.
